(19) United States
(12) Patent Application Publication
(10) Pub. No.: US 2007/0154386 A1
(43) Pub. Date: Jul. 5, 2007

(54) Method for Manufacturing Alpha Alumina Powders and Applications Thereof

(76) Inventors: Fu-Su Yen, Tainan City (TW); Hsiu-Wen Chen, Taipei City (TW); Rung-Je Yang, Qieding Shiang (TW); Pei-Ching Yu, Yuanshan Shiang (TW)

Correspondence Address: RAYMOND R. MOSER JR., ESQ.;MOSER IP LAW GROUP, 1040 BROAD STREET, 2ND FLOOR, SHREWSBURY, NJ, 07702, US

(21) Appl. No.: 11/612,185

(22) Filed: Dec. 18, 2006

(30) Foreign Application Priority Data
Jan. 2, 2006 (TW) 95100107

(51) Int. Cl. C01F 7/02

(52) U.S. Cl. 423/625

(57) ABSTRACT

A method for fabricating an α-Al₂O₃ powder with a size distribution substantially ranging from 30 nm to 100 nm, wherein the method comprises the following steps: First, at least one transition phase Al₂O₃ crystallite is provided, and then a coating process is conducted on the Al₂O₃ crystallite coating an aluminum compound on the Al₂O₃ crystallite to form a plurality of agglomerates having a size distribution substantially ranging from 50 nm to 200 nm. Subsequently, the agglomerates are thermally treated to form α-Al₂O₃ powder.

### RELATED APPLICATIONS

The present application is based on, and claims priority from, Taiwan Application Serial Number 95100107, filed Jan. 2, 2006, the disclosure of which is hereby incorporated by reference herein in its entirety.

### FIELD OF THE INVENTION

The present invention relates to a method for fabricating alumina (Al₂O₃) and applications thereof, and more particularly to a method for fabricating alpha alumina (α-Al₂O₃) and applications thereof.

### BACKGROUND OF THE INVENTION

α-Al₂O₃ is an easily obtainable material that has a high melting point, high abrasion resistance and high electrical insulation and as therefore a mechanically strong and chemically stable compound. The technology for fabricating α-Al₂O₃ is well known. During the 20^{th} century Al₂O₃ was applied in a wide variety of industries. For example, Al₂O₃ has been applied as an essential material in thermal tools, insulation materials, abrasion materials, cutting tools, sparking plugs, integrated circuits (ICs), artificial teeth, high-pressure sodium lamp, catalysts, and compound materials.

The method for synthesizing artificial Al₂O₃ powders was developed in 1881. α-Al₂O₃ powders are obtained by calcinations of boehmite or gibbsite purified from bauxite. Up to now Bayer's method still serves as the major industrial way for fabricating the precursors for producing α-Al₂O₃ powders.

However, the α-Al₂O₃ particles synthesized by calcinations of gibbsite or boehmite via Bayer's method have coarser particles with a wider range of particle size distribution. For industrial applications, post-treatments including sieving and classification processes are required. However, the size reduction performance of the post-grinding process is rather limited. Obtaining discrete nano-scaled α-Al₂O₃ particles of sizes smaller than 100 nm using the grinding process is difficult. Furthermore, powders obtained by grinding processes will be inevitably contaminated by chemically impurities due to consumption of grinding medium.

Currently, the gas phase process applying an aqueous solution containing organic aluminum salt as starting materials is the major way to form the discrete nano-scaled α-Al₂O₃ particles with sizes smaller than 100 nm. However, the gas phase process, including methods of flame hydrolysis of AlCl₃, arc evaporation of aluminum, liquid-feed flame spray pyrolysis (LF-FSP), ultrasonic flame pyrolyrosis (UFP), and laser ablation would provide a certain amount Al₂O₃ particles in various transition phases, such as γ-phase, δ-phase, and θ-phase. Al₂O₃ particles with pure α-phase are hardly obtained. Another conventional method for forming discrete nano-scaled α-Al₂O₃ particles is hydrothermal process. However there may be large variations in the sizes of the α-Al₂O₃ particles. Thus if α-Al₂O₃ powders of submicron grade are required, a post-grinding may be required to make the α-Al₂O₃ particles with sizes exceeding 100 nm into the desired nano-scale.

It is desirable, therefore, to provide a method with simpler and cheaper process to obtain discrete nano-scaled α-Al₂O₃ particles with purity and size consistency.

### SUMMARY OF THE INVENTION

One objective of the present invention is to provide a method for fabricating α-Al₂O₃ powders with consistent particles size substantially ranging from 30 nm to 100 nm.

The α-Al₂O₃ powder fabrication method comprises the following steps: First a plurality of transition phase Al₂O₃ crystallites are provided, and a coating process is then conducted on the transition Al₂O₃ crystallites to precipitate boehmite or gibbsite thereon to form a plurality of agglomerates with sizes ranging from 50 nm to 200 nm. Subsequently, a thermal treatment, such as calcinations, is conducted on these agglomerates to form α-Al₂O₃ particles with consistent particle sizes ranging from 30 nm to 100 nm.

Another objective of the present invention is to provide Al₂O₃ agglomerates with a core-shell structure having a size ranging from 50 nm to 200 nm, on which a thermal treatment can be conducted to form a plurality of α-Al₂O₃ particles with sizes ranging from 30 nm to 100 nm. Wherein, the core-shell structure comprises at least one transition phase Al₂O₃ crystallites serving as the core coated with a shell consisting of boehmite or gibbsite heterogeneously precipitated thereon.

In accordance with the aforementioned embodiments of present invention, the features of the present invention is to prepare Al₂O₃ agglomerates with a core-shell structure followed by a subsequent thermal treatment to form a plurality of α-Al₂O₃ particles having sizes ranging from 30 nm to 100 nm, wherein self-dimension may occur on the Al₂O₃ agglomerates to control the growth size of the α-Al₂O₃ particles during the thermal treatment. Whereby the prior problems caused by conventional method such as, process complexity, power wasting, and size inconsistency can be resolved.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates the particles size distribution curve of the core (θ-Al₂O₃ crystallites)-shell (boehmite) agglomerates in accordance with the embodiment 1.

FIG. 2 illustrates the differential thermal analysis (DTA) profile conducted on the core-shell agglomerates during the thermal treatment of the Embodiment 1.

FIG. 3 illustrates the X-ray diffraction (XRD) pattern of the α-Al₂O₃ powders provided by the Embodiment 1.

FIG. 4 illustrates the transmission electron microscopy (TEM) micrograph of the α-Al₂O₃ powders provided by the Embodiment 1.

FIG. 5 illustrates the X-ray diffraction (XRD) pattern of the α-Al₂O₃ powders provided by the Embodiment 2.

FIG. 6 illustrates the transmission electron. microscopy (TEM) micrograph of the α-Al₂O₃ powders provided by the Embodiment 2.

FIG. 7 illustrates the X-ray diffraction (XRD) pattern of the α-Al₂O₃ powders provided by the Embodiment 3.

FIG. 8 illustrates the transmission electron. microscopy (TEM) micrograph of the α-Al₂O₃ powders provided by the Embodiment 3.

### DETAILED DESCRIPTION OF THE PREFERRED EMBODIMENT

The objectives of the present invention are to provide α-Al₂O₃ powders with sizes ranging from 30 nm to 100 nm. The method of α-Al₂O₃ powders fabrication comprises steps as following:

First a plurality of transition phase Al₂O₃ crystallites are provided, wherein in some embodiments of the present invention, the transition phase Al₂O₃ crystallites may be δ-phases crystallites, θ-phase crystallites, κ-phase crystallites, χ-phase crystallites, γ-phase crystallites, or the arbitrary combination thereof.

A coating process is then conducted on the transition phase Al₂O₃ crystallites to precipitate an aluminum compound thereon to form a plurality of agglomerates with sizes ranging from 50 nm to 200 nm. Wherein, the transition phase Al₂O₃ crystallites are coated with the precipitated aluminum compound to form a core-shell structure (particle).

In the embodiments of the present invention, the aluminum compound is boehmite, gibbsite or a combination thereof. In some preferred embodiments of the present invention, the aluminum compound (boehmite or gibbsite) can be obtained by neutralizing an aqueous solution containing inorganic aluminum salt, such as (Al(NO₃)₃.9H₂O), Al(SO₄)₃, or the combination thereof. However, in some other preferred embodiments of the present invention, the aluminum compound (boehmite or gibbsite) can be obtained by hydrolyzing aluminum alcoholate, such as aluminum isopropoxide, aluminum isobutoxide, or the combination thereof.

In the embodiments of the present invention, at least one of the transition phase Al₂O₃ crystallites that serves as a core is coated by a shell that consists of boehmite or gibbsite to form a particle of the agglomerates. Wherein, each agglomerated particle with a core-shell structure comprises a plurality of particles constructed by a single transition phase Al₂O₃ crystallite core coated by a boehmite or gibbsite shell. However, in other embodiments of the present invention, the agglomerates may involve a plurality of particles constructed by plural transition phase Al₂O₃ crystallites as the core coated by a boehmite or gibbsite shell.

Subsequently, thermal treatment, such as calcinations, is conducted on these agglomerates to form the α-Al₂O₃ particles with sizes ranging from 30 nm to 100 nm, wherein the operating temperature of the thermal treatment substantially ranges from 1,000° C. to 1,200° C.

The phase transformation of Al₂O₃ from θ-phase to α-phase is well known. Recent studies have demonstrated there are critical and primary crystallite sizes for the θ-phase to α-phase transformation of nano-scaled Al₂O₃ particles. During the θ-phase to α-phase transformation of Al₂O₃, θ-Al₂O₃ crystallites growth exceeds the critical size of 25 nm that is a prerequisite for the formation of the α-Al₂O₃ nucleus (size about 20 nm). During the θ-phase to α-phase transformation, when the prerequisite of the critical size is reached, nucleation of α-Al₂O₃ occurs. Continuous thermal treatment then leads to the coalescence of the α-Al₂O₃ nucleus beyond the primary size of 45 nm, and finally completes the phase transformation, wherein the growth of the α-Al₂O₃ crystallites may not stop until the size is about 100 nm. There exists a self-dimension characteristic during the growth of the α-Al₂O₃ crystallites. The size of grown α-Al₂O₃ crystallites can be maintained about 100 nm, if the α-Al₂O₃ particles can be separated from one another in a certain distance during the coalescence step in that prevents the vermicular growth of α-Al₂O₃ crystallites.

The feature of the present invention is to apply agglomerates with sizes ranging from 50 nm to 200 nm as a starting material for fabricating α-Al₂O₃ powders. The size is larger than that needed for forming which size for θ- to α-Al₂O₃ phase transformation. Furthermore, the mass transfer occurs within each particle of the agglomerates can be faster than that occurs between the particles of the agglomerates. Thus the θ-phase to α-phase transformation of the Al₂O₃ agglomerates can be restricted easily within each particle of the agglomerates. This would limit the crystallite growth within the agglomerates and prevent the occurrence of vermicular growth of α-Al₂O₃ crystallites so as to obtain α-Al₂O₃ particles with sizes ranging from 30 nm to 100 nm.

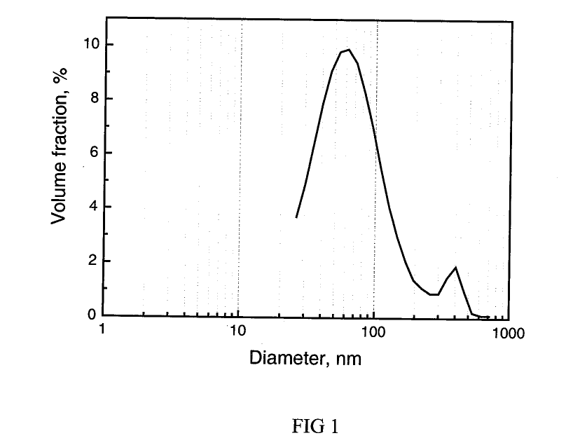

The foregoing aspects and many of the attendant advantages of this invention will become better understood by reference to the following embodiments for fabricating nano-sacled α-Al₂O₃ powders and taken in conjunction with the accompanying drawings of FIGS. 1-8

### Embodiment 1

Core-shell agglomerates are prepared by precipitating a shell consisting of boehmite over θ-Al₂O₃ crystallites that serve as a core, wherein boehmite is obtained by titrating an aqueous solution containing Al(NO₃)₃ with NH₄OH. The core-shell agglomerates are then thermally treated to form α-Al₂O₃ particles with a uniform size ranging from 30 nm to 100 nm. The detailed descriptions of the fabrication method are as follows:

θ-Al₂O₃ crystallites are first well dispersed in an aqueous solution containing Al(NO₃)₃ of pH 4. The aqueous solution is then titrated with NH₄OH to precipitate boehmite over the θ-Al₂O₃ crystallites, whereby uniform agglomerates with core-shell structure are prepared. In the preferred embodiment, the number of θ-Al₂O₃ crystallites added in the aqueous solution could control the θ-Al₂O₃ to boehmite weight ratio, and the θ-Al₂O₃ to boehmite weight ratio of the present embodiment is about 40:60.

FIG. 1 illustrates the particles size distribution curve of the core (θ-Al₂O₃ crystallites)-shell (boehmite) agglomerates in accordance with the embodiment 1. The particles size distribution curve shown in FIG. 1 is determined by using an apparatus of Malvern Instrument Zetasizer 1000®. In accordance with FIG. 1, the particles size substantially ranges from 50 nm to 200 nm.

Subsequently, the core-shell agglomerates are heated to 1050° C. at a heating rate of 10° C./minute, and the temperature is then maintained for about 10 to 20 minutes to complete the θ- to α-Al₂O₃ phase transformation. And the α-Al₂O₃ powder is obtained.

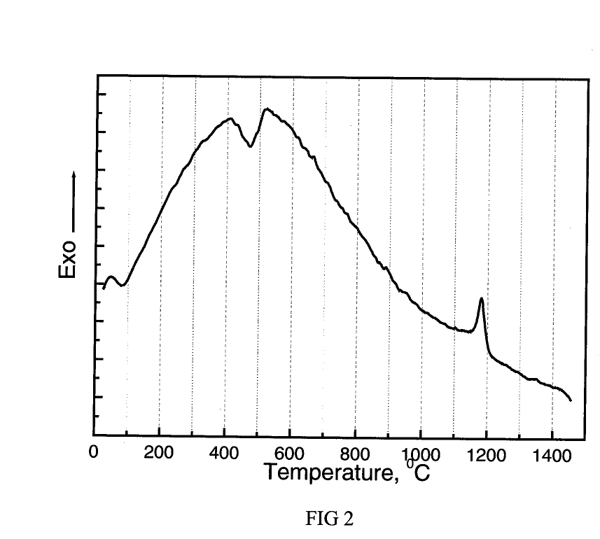

A differential thermal analysis (DTA) is conducted on the core-shell agglomerates. The results of DTA shown in FIG. 2 illustrates that the exothermic pick primarily vary within the range of 1,150° C. to 1,200° C. This could indicate that the transformation is very centralized, and the temperature of θ- to α-Al₂O₃ phase transformation is rather low.

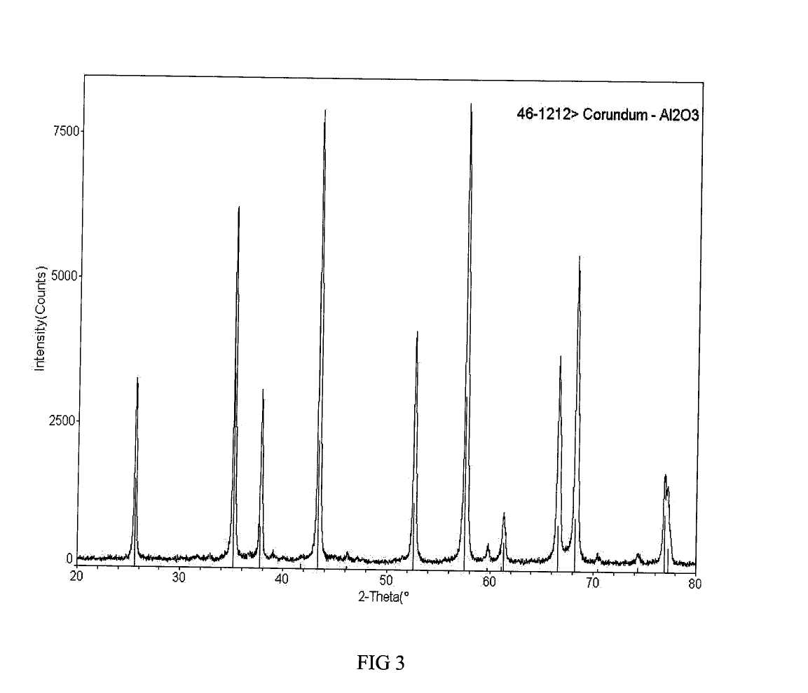

The crystallite phase of the α-Al₂O₃ powders provided by the Embodiment 1 is then identified by X-ray diffraction (XRD; Rigaku MiniFlex®) powder method using CuKα1 radiation, 2θ=20˜80°. FIG. 3 illustrates the XRD pattern of the Al₂O₃ powders provided by the Embodiment 1 after thermal heating the core-shell agglomerates that consist of θ-Al₂O₃ crystallites and boehmite. The XRD powder methods determine the amount of α-Al₂O₃ phase formation, wherein the internal standard is CaF₂, and the calculation is performed with software, “XRD Pattern Processing and Identification”, Jade for Windows, Version 5.0 developed by Material Data Inc. In accordance with the XRD pattern shown in FIG. 3, the Al₂O₃ powders provided by the Embodiment 1 after the thermal treatment consist of α-Al₂O₃ particles with a small amount of transition Al₂O₃.

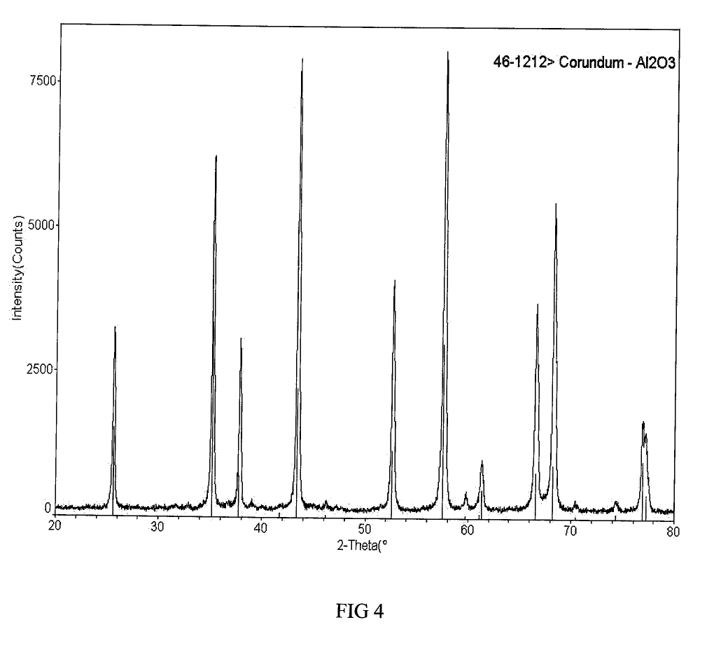

Meanwhile, the mean particle size of the α-Al₂O₃ powders provided by the Embodiment 1 is derived by measuring the specific surface areas determined by the Brunauer-Emmett-Teller (BET) method, a conventional nitrogen adsorption technique with the Gemini 2360® apparatus. In accordance with the result of the BET test, the specific surface areas of the α-Al₂O₃ powders provided by the embodiment are measured to be about 19 m²/g, and the mean particle size of the α-Al₂O₃ powders derived from the BET value is less than 100 nm. This result can be proved with the transmission electron microscopy (TEM) micrograph shown in FIG. 4, wherein each α-Al₂O₃ particle illustrated in FIG. 4 is less than 100 nm.

### Embodiment 2

Core-shell agglomerates are prepared by precipitating boehmite shell over γ-Al₂O₃ crystallites that serve as a core, wherein boehmite is obtained by titrating an aqueous solution containing Al(NO₃)₃ with NH₄OH. The core-shell agglomerates are then thermally treated to form α-Al₂O₃ particles with uniform sizes ranging from 30 nm to 100 nm. The detailed descriptions of the fabrication method are followed as:

γ-Al₂O₃ crystallites are first well dispersed in an aqueous solution containing Al(NO₃)₃ of pH 4. The aqueous solution is then titrated with NH₄OH to precipitate boehmite over γ-Al₂O₃ crystallites, whereby uniform agglomerates with core-shell structure are prepared. In the preferred embodiment, the number of γ-Al₂O₃ crystallites added in the aqueous solution could control the γ-Al₂O₃ to boehmite weight ratio, and the γ-Al₂O₃ to boehmite weight ratio of the present embodiment is about 30:70.

Subsequently, the core-shell agglomerates are heated to 1075° C. at a heating rate of 10° C./minute, and the temperature is then maintained for about 10 to 20 minutes to complete the θ- to α-Al₂O₃ phase transformation. And the α-Al₂O₃ powder is obtained.

The crystallite phase of the α-Al₂O₃ powders provided by the Embodiment 2 is then identified by X-ray diffraction (XRD; Rigaku MiniFlex®) powder method using CuKα1 radiation, 2θ=20˜80°. FIG. 5 illustrates the XRD pattern of the Al₂O₃ particles provided by Embodiment 2 after thermally heating the core-shell agglomerates. The XRD powder methods determine the amount of the α-Al₂O₃ phase formation, wherein the internal standard is CaF₂, and the calculation is performed using software, “XRD Pattern Processing and Identification”, Jade for Windows, Version 5.0 developed by Material Data Inc. In accordance with the XRD pattern shown in FIG. 5, the Al₂O₃ powders provided by the Embodiment 2 consist of α-Al₂O₃ particles with a small amount of transition Al₂O₃.

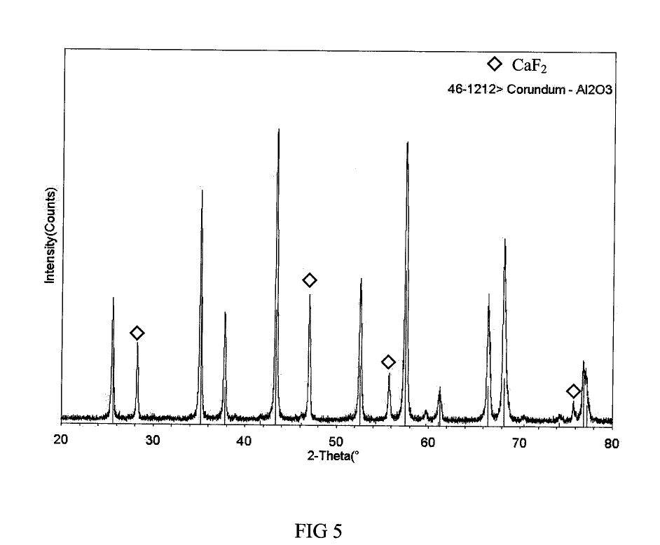

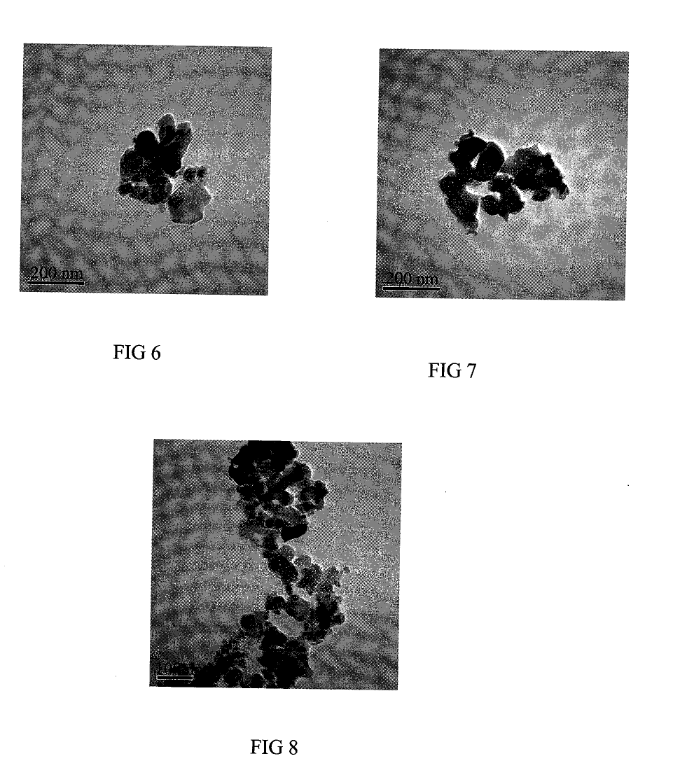

Meanwhile, the mean particle size of the α-Al₂O₃ powders provided by Embodiment 2 is derived by measuring the specific surface areas determined by the Brunauer-Emmett-Teller (BET) method, a conventional nitrogen adsorption technique that uses the Gemini 2360 apparatus. In accordance with the result of the BET test, the specific surface areas of the α-Al₂O₃ powders provided by the embodiment is measured to be about 18 m²/g, and the mean particle size of the α-Al₂O₃ powders derived from the BET value is less than 100 nm. This result can be proved with the TEM micrograph shown in FIG. 6, wherein each α-Al₂O₃ particle illustrated in FIG. 6 is less than 100 nm.

### Embodiment 3

Core-shell agglomerates are prepared by precipitating a boehmite shell over θ-Al₂O₃ crystallites that serve as a core, wherein boehmite is obtained by hydrolyzing aluminum isopropoxide. The core-shell agglomerates are then thermally treated to form α-Al₂O₃ particles with a uniform size ranging from 30 nm to 100 nm. The detailed descriptions of the fabrication method are followed as:

θ-Al₂O₃ crystallites are first well dispersed in an aqueous solution containing aluminum isopropoxide of pH 4. The aqueous solution is then heated to 80° C. for hydrolyzing aluminum isopropoxide to form boehmite. The boehmite resulting from hydrolyzed aluminum isopropoxide is precipitated over θ-Al₂O₃ crystallites, whereby uniform agglomerates with core-shell structure are prepared. In the preferred embodiment, the number of θ-Al₂O₃ crystallites added in the aqueous solution could control the θ-Al₂O₃ to boehmite weight ratio, and the θ-Al₂O₃ to boehmite weight ratio maybe about 50:50.

Subsequently, the core-shell agglomerates are heated to 1050° C. at a heating rate of 10° C./minute, and the temperature is then maintained for about 10 to 20 minutes to complete the θ- to α-Al₂O₃ phase transformation. And the α-Al₂O₃ powder is obtained.

The crystallite phase of the α-Al₂O₃ powders provided by the Embodiment 3 is then identified by X-ray diffraction (XRD; Rigaku MiniFlex®) powder method using CuKα1 radiation, 2θ=20˜80°. FIG. 7 illustrates the XRD pattern of the Al₂O₃ powders provided by the Embodiment 3 after thermally heating the core-shell agglomerates. The XRD powder methods determine the amount of the α-Al₂O₃ phase formation, wherein the internal standard is CaF₂, and the calculation is performed using software, “XRD Pattern Processing and Identification”, Jade for Windows, Version 5.0 developed by Material Data Inc. In accordance with the XRD pattern shown in FIG. 7, the Al₂O₃ powders provided by the Embodiment 3 consist of α-Al₂O₃ particles with a small amount of transition Al₂O₃.

Meanwhile, the mean particle size of the α-Al₂O₃ powders provided by the Embodiment 3 is derived by measuring the specific surface areas determined by the Brunauer-Emmett-Teller (BET) method, a conventional nitrogen adsorption technique with Gemini 2360® apparatus. In accordance with the result of the BET test, the specific surface areas of the α-Al₂O₃ powders provided by the embodiment are measured to be about 22 m²/g, and the mean particle size of the α-Al₂O₃ powders derived from the BET value is less than 100 nm. This result can be proved by the TEM micrograph shown in FIG. 8, wherein each α-Al₂O₃ particle illustrated in FIG. 8 is less than 100 nm.

In accordance with the aforementioned embodiments of present invention, the features of the present invention is to provide a core (transition phase Al₂O₃ crystallites)-shell (boehmite) agglomerates to transform the agglomerates into α-Al₂O₃ particles via a thermal treatment. Since the Al₂O₃ crystallites can be separated from one another by a certain distance, self-dimension may occur on the Al₂O₃ agglomerates to prevent vermicular growth occuring during the thermal treatment so as to control the growth size of the α-Al₂O₃ particles ranging from about 30 nm to 100 nm. Therefore, there is no need for any additional post-girding process to obtain uniform nano-scaled α-Al₂O₃ particles. Accordingly, the method provide by the present invention indeed can resolve the prior problems caused by conventional method such as, process complexity, power wasting, and size inconsistency can be resolved.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A method for fabricating an α-Al₂O₃ powder with a size substantially ranging from 30 nm to 100 nm, comprising:
providing at least one transition phase Al₂O₃ crystallite;
conducting a coating process, coating an aluminum compound on the transition phase Al₂O₃ crystallite to form a plurality of agglomerates having a size substantially ranging from 30 nm to 200 nm; and
thermally treating the agglomerates.

2. The method according to claim 1, wherein the transition phase Al₂O₃ crystallite is selected from the group consisting of a θ-Al₂O₃ crystallite, a δ-Al₂O₃ crystallite, a κ-Al₂O₃ crystallite, an χ-Al₂O₃ crystallite, a γ-Al₂O₃ crystallite and the arbitrary combination thereof.

3. The method according to claim 1, wherein the aluminum compound is selected form the group consisting of boehmite, gibbsite and the combination thereof.

4. The method according to claim 1, wherein the coating process comprises:
neutralizing an aqueous solution containing inorganic aluminum salt to form boehmite; and
precipitating boehmite over the transition phase Al₂O₃ crystallite.

5. The method according to claim 4, wherein the inorganic aluminum salt is selected form the group consisting of (Al(NO₃)₃.9H₂O), Al(SO₄)₃ and the combination thereof.

6. The method according to claim 1, wherein the coating process comprises:
hydrolyzing an aluminum alcoholate to form boehmite; and
precipitating boehmite over the transition phase Al₂O₃ crystallite.

7. The method according to claim 6, wherein the aluminum alcoholate is selected form the group consisting of aluminum isopropoxide, aluminum isobutoxide and the combination thereof.

8. The method according to claim 1, wherein each of the agglomerates substantially comprises 10% to 50% the transition phase Al₂O₃ crystallite by weight.

9. The method according to claim 1, wherein the thermal treatment is conducted under an operation temperature substantially ranging from 1,000° C. to 1,200° C.

10. The method according to claim 1, wherein the agglomerates provided by the coating process comprises a core-shell structure.

11. An Al₂O₃ agglomerate with a particle size substantially ranging from 50 nm to 200 nm, comprising:
a transition phase Al₂O₃ crystallite; and
an aluminum compound coating over the Al₂O₃ crystallite.

12. The Al₂O₃ agglomerate according to claim 1, wherein the aluminum compound is selected form the group consisting of boehmite, gibbsite and the combination thereof.

13. The Al₂O₃ agglomerate according to claim 1, wherein the Al₂O₃ crystallite is selected from the group consisting of a θ-Al₂O₃ crystallite, a δ-Al₂O₃ crystallite, a κ-Al₂O₃ crystallite, an χ-Al₂O₃ crystallite, a γ-Al₂O₃ crystallite and the arbitrary combination thereof.

14. The Al₂O₃ agglomerate according to claim 1, wherein the agglomerate substantially comprises 10% to 50% the transition phase Al₂O₃ crystallite by weight.

15. The Al₂O₃ agglomerate according to claim 1, wherein the agglomerate is constructed by a core-shell structure particle.

16. The Al₂O₃ agglomerate according to claim 1, wherein the agglomerate is constructed by a plurality of core-shell structure particles.
